(19) United States
(12) Patent Application Publication
(10) Pub. No.: US 2025/0175393 A1
(43) Pub. Date: May 29, 2025

(54) Iterative Learning Process using Over-the-Air Transmission and Unicast Digital Transmission

(71) Applicant: Telefonaktiebolaget LM Ericsson (publ), Stockholm (SE)

(72) Inventors: Reza Moosavi, Linköping (SE); Henrik Rydén, Stockholm (SE); Zheng Chen, Linköping (SE); Erik G. Larsson, Linköping (SE)

(21) Appl. No.: 18/841,899

(22) PCT Filed: Feb. 28, 2022
(86) PCT No.: PCT/EP2022/054949

§ 371 Date: Aug. 27, 2024

(51) Int. Cl. H04L 41/16; H04L 41/044; H04W 28/16

(52) U.S. Cl. CPC H04L 41/16; H04L 41/044; H04W 28/16

(57) ABSTRACT

There is provided mechanisms for performing an iterative learning process with agent entities. A method is performed by a server entity. The method comprises partitioning the agent entities into clusters with one cluster head per each of the clusters. The method comprises configuring the agent entities to, as part of performing the iterative learning process, use over-the-air transmission with direct analog modulation for communicating local updates of the iterative learning process to the cluster head. The method comprises configuring the cluster head of each cluster to, as part of performing the iterative learning process aggregate the local updates received from the agent entities within its cluster, and use unicast digital transmission for communicating aggregated local updates to the server entity. The method comprises performing at last one iteration of the iterative learning process with the agent entities and the cluster heads according to the configuration.

### TECHNICAL FIELD

Embodiments presented herein relate to a method, a server entity, a computer program, and a computer program product for performing an iterative learning process with agent entities. Further embodiments presented herein relate to a method, an agent entity, a computer program, and a computer program product for performing an iterative learning process with a server entity and a cluster head. Further embodiments presented herein relate to a method, an agent entity, a computer program, and a computer program product for performing an iterative learning process with a server entity and agent entities.

### BACKGROUND

The increasing concerns for data privacy have motivated the consideration of collaborative machine learning systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

FL is an iterative process where each global iteration, often referred to as communication round, is divided into three phases: In a first phase the PS broadcasts the current model parameter vector to all participating agents. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

A common baseline scheme in FL is named Federated SGD, where in each local iteration, only one step of SGD is performed at each participating agent, and the model updates contain the gradient information. A natural extension is so-called Federated Averaging, where the model updates from the agents contain the updated parameter vector after performing their local iterations.

The above baseline schemes are based on the participating agents using direct analog modulation when sending their model updates. This is sometimes referred to as over-the-air federated learning. Such direct analog modulation, and thus also over-the-air federated learning, is susceptible to interference as well as to other types of channel degradations, such as noise, etc.

### SUMMARY

An object of embodiments herein is to address the above issues in order to enable efficient communication between the agents (hereinafter denoted agent entities) and the PS (hereinafter denoted server entity) in scenarios impacted by channel degradations.

According to a first aspect there is presented a method for performing an iterative learning process with agent entities. The method is performed by a server entity. The method comprises partitioning the agent entities into clusters with one cluster head per each of the clusters. The method comprises configuring the agent entities to, as part of performing the iterative learning process, use over-the-air transmission with direct analog modulation for communicating local updates of the iterative learning process to the cluster head. The method comprises configuring the cluster head of each cluster to, as part of performing the iterative learning process aggregate the local updates received from the agent entities within its cluster, and use unicast digital transmission for communicating aggregated local updates to the server entity. The method comprises performing at last one iteration of the iterative learning process with the agent entities and the cluster heads according to the configuration.

According to a second aspect there is presented a server entity for performing an iterative learning process with agent entities. The server entity comprises processing circuitry. The processing circuitry is configured to cause the server entity to partition the agent entities into clusters with one cluster head per each of the clusters. The processing circuitry is configured to cause the server entity to configure the agent entities to, as part of performing the iterative learning process, use over-the-air transmission with direct analog modulation for communicating local updates of the iterative learning process to the cluster head. The processing circuitry is configured to cause the server entity to configure the cluster head of each cluster to, as part of performing the iterative learning process aggregate the local updates received from the agent entities within its cluster, and use unicast digital transmission for communicating aggregated local updates to the server entity. The processing circuitry is configured to cause the server entity to perform at last one iteration of the iterative learning process with the agent entities and the cluster heads according to the configuration.

According to a third aspect there is presented a computer program for performing an iterative learning process with agent entities, the computer program comprising computer program code which, when run on processing circuitry of a server entity, causes the server entity to perform a method according to the first aspect.

According to a fourth aspect there is presented a method for performing an iterative learning process with a server entity and a cluster head. The method is performed by an agent entity. The agent entity is part of a cluster having a cluster head. The method comprises receiving configuration from the server entity. According to the configuration, the agent entity is to, as part of performing the iterative learning process, use over-the-air transmission with direct analog modulation for communicating local updates of the iterative learning process to the cluster head. The method comprises performing at least one iteration of the iterative learning process with the server entity and the cluster head according to the configuration.

According to a fifth aspect there is presented an agent entity for performing an iterative learning process with a server entity and a cluster head. The agent entity comprises processing circuitry. The processing circuitry is configured to cause the agent entity to receive configuration from the server entity. According to the configuration, the agent entity is to, as part of performing the iterative learning process, use over-the-air transmission with direct analog modulation for communicating local updates of the iterative learning process to the cluster head. The processing circuitry is configured to cause the agent entity to perform at least one iteration of the iterative learning process with the server entity and the cluster head according to the configuration.

According to a sixth aspect there is presented a computer program for performing an iterative learning process with a server entity and a cluster head, the computer program comprising computer program code which, when run on processing circuitry of an agent entity, causes the agent entity to perform a method according to the fourth aspect.

According to a seventh aspect there is presented a method for performing an iterative learning process with a server entity and agent entities. The method is performed by an agent entity. The agent entity acts as a cluster head of a cluster of agent entities. The method comprises receiving configuration from the server entity. According to the configuration, the agent entity is to, as part of performing the iterative learning process, aggregate local updates received in over-the-air transmission with direct analog modulation from the agent entities within the cluster and to use unicast digital transmission for communicating the aggregated local updates to the server entity. The method comprises performing at least one iteration of the iterative learning process with the server entity and the agent entities within the cluster according to the configuration.

According to an eighth aspect there is presented an agent entity for performing an iterative learning process with a server entity and agent entities. The agent entity comprises processing circuitry. The processing circuitry is configured to cause the agent entity to receive configuration from the server entity. According to the configuration, the agent entity is to, as part of performing the iterative learning process, aggregate local updates received in over-the-air transmission with direct analog modulation from the agent entities within the cluster and to use unicast digital transmission for communicating the aggregated local updates to the server entity. The processing circuitry is configured to cause the agent entity to perform at least one iteration of the iterative learning process with the server entity and the agent entities within the cluster according to the configuration.

According to a tenth aspect there is presented a computer program for performing an iterative learning process with a server entity and agent entities, the computer program comprising computer program code which, when run on processing circuitry of an agent entity, causes the agent entity to perform a method according to the seventh aspect.

According to an eleventh aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously, these aspects ensure the participation of as many agent entities as possible in total in the iterative learning process. This can be useful in heterogeneous scenarios where the agent entities do not have independent and identically distributed training data. This is because the overall pathloss is lower than if all agent entities communicate directly with the server entity.

Advantageously, thanks to that over-the-air transmission with direct analog modulation is used for communication within clusters, resources are used more efficiently than with traditional unicast digital transmission. At the same time, the data transmission from the cluster heads to the server entity (which is more important, in that it contains more information) is protected through digital modulation and error correcting/detecting codes, by virtue of the unicast digital transmission format.

Advantageously, these aspects are more energy-efficient than traditional iterative learning processes using either only unicast digital transmission or only over-the-air transmission with direct analog modulation.

Advantageously, these aspects enable the server entity to implement algorithms to detect whether the aggregation within a cluster has been compromised, for example, subjected to jamming.

Advantageously, these aspects enable the server entity to implement algorithms to detect whether any one cluster contains a misbehaving (malicious) agent entity that attempts to intentionally poison the model, or whether the cluster head itself is misbehaving.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIGS. 3, 6, 7, 8, 9, and 10 are flowcharts of methods according to embodiments;

FIGS. 4 and 5 are schematic diagrams illustrating parts of a communication network according to embodiments;

FIG. 11 is a signalling diagram according to an embodiment;

FIG. 12 is a schematic diagram showing functional units of a server entity according to an embodiment;

FIG. 13 is a schematic diagram showing functional modules of a server entity according to an embodiment;

FIG. 14 is a schematic diagram showing functional units of an agent entity according to an embodiment;

FIG. 15 is a schematic diagram showing functional modules of an agent entity according to an embodiment;

FIG. 16 shows one example of a computer program product comprising computer readable means according to an embodiment

FIG. 17 is a schematic diagram illustrating a telecommunication network connected via an intermediate network to a host computer in accordance with some embodiments; and

FIG. 18 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

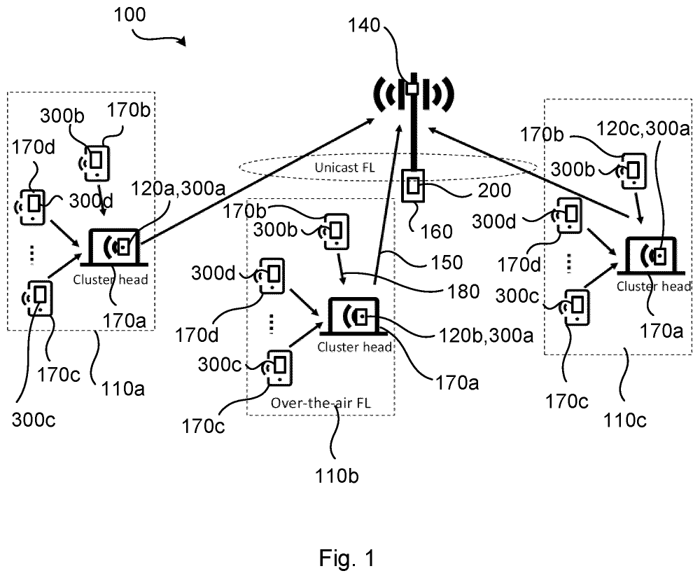

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170b, 170c in an (radio) access network over a radio propagation channel 150. The access network is operatively connected to a core network. The core network is in turn operatively connected to a service network, such as the Internet. The user equipment 170a:170c is thereby, via the transmission and reception point 140, enabled to access services of, and exchange data with, the service network 130.

Operation of the transmission and reception point 140 is controlled by a network node 160. The network node 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170c are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170c are to be utilized during an iterative learning process and that the user equipment 170a:170c as part of performing the iterative learning process are to report computational results to the network node 160. Each of the user equipment 170a:170c comprises, is collocated with, or integrated with, a respective agent entity 300a, 300b, 300c. In the example of FIG. 1, the network node 160 comprises, is collocated with, or integrated with, a server entity 200. Further in this respect, the server entity 200 might be provided in any of: an access network node, a core network node, an Operations, Administration and Maintenance (OAM) node, a Service Management and Orchestration (SMO) node.

According to the illustrative example in FIG. 1, the agent entities 300a:300c have been partitioned in clusters 110a, 110b, 110c, with one cluster head 120a, 120b, 120c per cluster 110a, 110b, 110c. Communication between the agent entities 300a:300c occurs over wireless links, as illustrated at reference numeral 180. Aspects of how the agent entities 300a:300c might be partitioned into the clusters 110a:110c and how the cluster heads 120a:120c might be selected will be disclosed below.

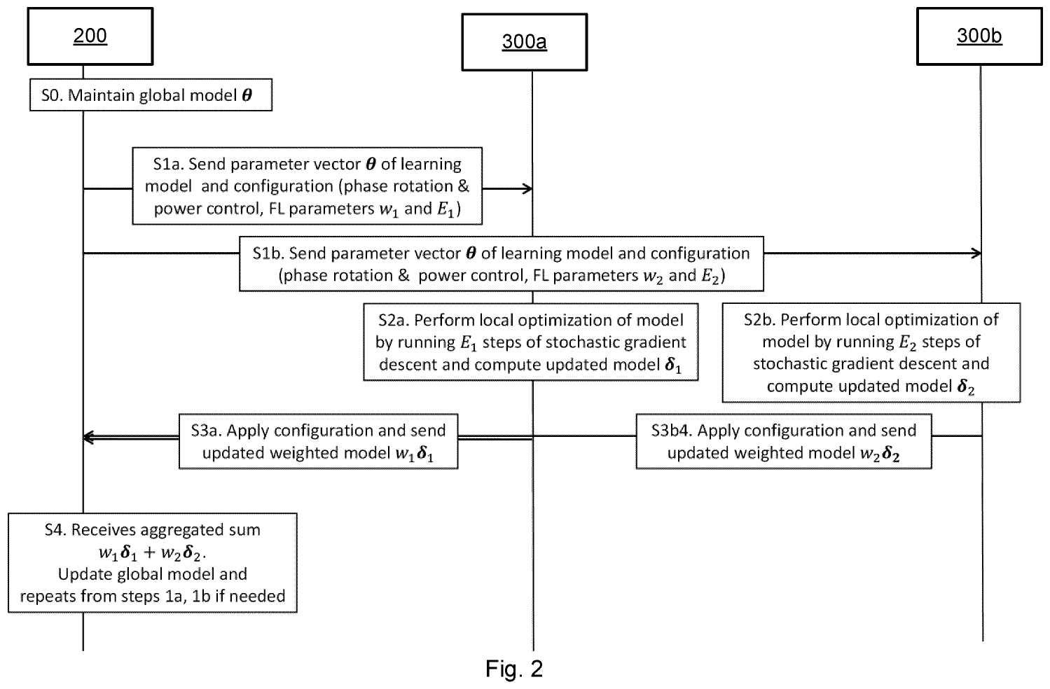

Reference is next made to the signalling diagram of FIG. 2, illustrating an examples of a nominal iterative learning process. This nominal iterative learning process is transparent to which agent entities 300a:300c belong to which cluster 110a:110c.

Consider a setup with K agent entities 300a:300K, and one server entity 200. Each transmission from the agent entities 300a:300K is allocated N resource elements (REs). These can be time/frequency samples, or spatial modes. For simplicity, but without loss of generality, the example in FIG. 2 is shown for two agent entities 300a, 300b, but the principles hold also for larger number of agent entities 300a:300K.

The server entity 200 updates its estimate of the learning model (maintained as a global model θ in step S0), as defined by a parameter vector θ(i), by performing global iterations with an iteration time index i. The parameter vector θ(i) is assumed to be an N-dimensional vector. At each iteration i, the following steps are performed:

Steps S1a, S1b: The server entity 200 broadcasts the current parameter vector of the learning model, θ(i), to the agent entities 300a, 300b.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) τ = 1 , … , T ,$$

where ηₖ is a weight and ƒₖ is the objective function used at agent entity k (and which is based on its locally available training data).

Steps S3a, S3b: Each agent entity 300a, 300b transmits to the server entity 200 their model update δₖ(i);

$${δ}_{k} ( i ) = {θ}_{k} ( i , T ) - {θ}_{k} ( i , 0 ) ,$$

where θk (i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

Assume now that there are K agent entities and hence K model updates. When the model updates {δ₁, . . . , δ_{K}} (where the time index has been dropped for simplicity) from the agent entities 300a:300K over a wireless communication channel, there are specific benefits of using direct analog modulation. For analog modulation, the k:th agent entity could transmit the N components of δₖ directly over N resource elements (REs). Here an RE could be, for example: (i) one sample in time in a single-carrier system, or (ii) one subcarrier in one orthogonal frequency-division multiplexing (OFDM) symbol in a multicarrier system, or (iii) a particular spatial beam or a combination of a beam and a time/frequency resource.

One benefit of direct analog modulation is that the superposition nature of the wireless communication channel can be exploited to compute the aggregated update, δ₁+δ₂+ . . . +δₖ. More specifically, rather than sending δ₁, . . . , δ_{K} to the server entity 200 on separate channels, the agent entities 300a:300K could send the model updates {δ₁, . . . , δ_{K}} simultaneously, using N REs, through linear analog modulation. The server entity 200 could then exploit the wave superposition property of the wireless communication channel, namely that {δ₁, . . . , δ_{K}} add up “in the air”. Neglecting noise and interference, the server entity 200 would thus receive the linear sum, δ₁+δ₂+ . . . +δ_{K}, as desired. That is, the server entity 200 ultimately is interested only in the aggregated model update δ₁+δ₂+ . . . +δ_{K}, but not in each individual parameter vector {δ₁, . . . , δ_{K}}. This technique can thus be referred to as iterative learning with over-the-air computation.

The over-the-air computation assumes that appropriate power control is applied (such that all transmissions of {δₖ} are received at the server entity 200 with the same power), and that each transmitted δₖ is appropriately phase-rotated prior to transmission to pre-compensate for the phase rotation incurred by the channel from agent entity k to the server entity 200.

One benefit of the thus described over-the-air computation is the savings of radio resources. With two agents (K=2), 50% resources are saved compared to standard FL since the two agent entities can send their model updates simultaneously in the same RE. With K agent entities, only a fraction 1/K of the nominally required resources are needed.

On the other hand, with unicast digital transmission, each of the K agent entities is allocated orthogonal resources for the transmission of its gradient update to the server entity 200. That is, the k:th agent entity first compresses its gradient (which may include sparsification, i.e., setting small components of δₖ to zero), then apply an error-correcting code, and then perform digital modulation, before transmission. The number of resource elements (REs) allocated to a specific agent k may be adapted depending on the size of its gradient (after compression), and the signal-to-noise-and-interference ratio of the channel for agent k.

Iterative learning based on unicast digital transmission is comparatively resource inefficient since all agent entities must be multiplexed on orthogonal resources. If the number of agent entities is comparatively large, the transmission consumes substantial system resources. Some gradient vectors might comprise hundreds of millions of components.

Iterative learning based on over-the-air transmission with direct analog modulation, on the other hand, is comparatively resource efficient as all K agent entities transmit their updates simultaneously. However, over-the-air transmission with direct analog modulation is less robust than unicast digital transmission as over-the-air transmission with direct analog modulation does not offer any mechanisms for error control or correction. For example, it is difficult for the server entity to detect whether strong out-of-cell or out-of-system interference (or even intentional jamming/spoofing signals) are present. Any unwanted signals that reach the server entity will contaminate the received sum-gradient, and consequently affect model convergence. In addition, since only the sum of the gradients is received, there is no way for the server entity to detect whether an agent entity is malicious or misbehaving. Another issue is that all participating agent entities must apply inverse-path-loss power control such that the signals from all agent entities are received at the server entity with the same power. In practice this means that the agent entity that is farthest away (in the sense of largest pathloss) will have to use its maximum permitted power, and all other agent entities will have to reduce power proportionally to the difference between their pathloss and the farthest-away agent entity. If the farthest-away agent entity has a very large pathloss (e.g., is located at the cell border) then other agent entities may be forced to cut back significantly (perhaps 30-40 dB) on power, which results in a small overall received power at the server entity, this consequently increases the susceptibility to thermal noise and out-of-cell/out-of-system interference. Hence, the agent entity with the largest pathloss will determine the eventual performance.

In view of the above there is therefore a need for improved iterative learning processes.

At least some of the herein disclosed embodiments are based on that a set of agent entities is partitioned into clusters. For each cluster, a cluster head is selected. Each cluster head aggregates gradients from the agent entities within the cluster, and forwards the aggregate to the server entity. When performing aggregation within a cluster, over-the-air transmission with direct analog modulation is used. But when the aggregates are transmitted from the cluster heads to the server entity, unicast digital transmission is used.

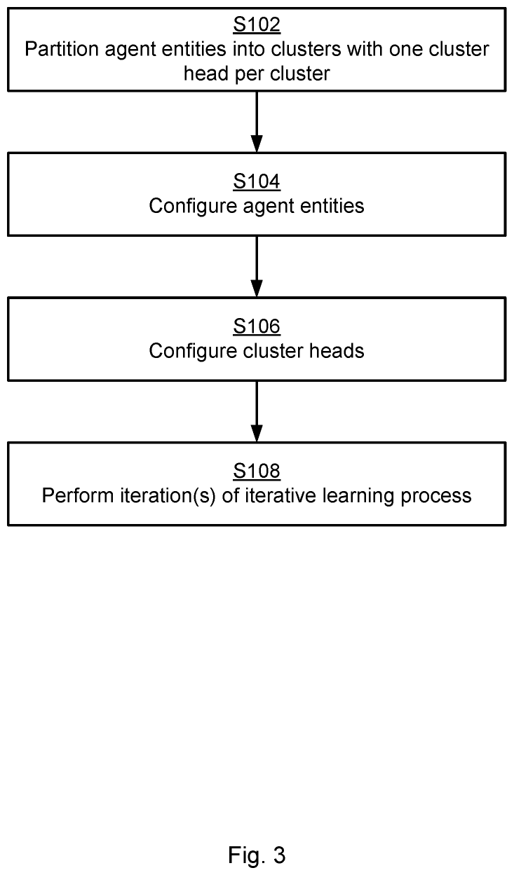

Reference is now made to FIG. 3 illustrating a method for performing an iterative learning process with agent entities 300a:300c as performed by the server entity 200 according to an embodiment.

S102: The server entity 200 partitions the agent entities 300a:300c into clusters 110a:110c with one cluster head 120a:120c per each of the clusters 110a:110c.

Each agent entity 300a:300c might selectively act as either a cluster member or a cluster head 120a:120c. That is, in some examples, in at least one of the clusters 110a:110c, one of the agent entities 300a acts as cluster head 120a:120c. The remaining agent entities in the cluster then act as cluster members. For illustrative purpose it is hereinafter assumed that agent entity 300a acts as cluster head and agent entities 300b, 300c act as cluster members.

S104: The server entity 200 configures the agent entities 300b, 300c to, as part of performing the iterative learning process:
i) use over-the-air transmission with direct analog modulation for communicating local updates of the iterative learning process to the cluster head 120a:120c.

S106: The server entity 200 configures the cluster head 120a:120c of each cluster 110a:110c to, as part of performing the iterative learning process:
i) aggregate the local updates received from the agent entities 300b, 300c within its cluster 110a:110c, and
ii) use unicast digital transmission for communicating aggregated local updates to the server entity 200.

S108: The server entity 200 performs at last one iteration of the iterative learning process with the agent entities 300a:300c and the cluster heads 120a:120c according to the configuration.

Embodiments relating to further details of performing an iterative learning process with agent entities 300a:300c as performed by the server entity 200 will now be disclosed.

Aspects of factors based on which the agent entities 300a:300c might be partitioned into the clusters 110a:110c and/or based on which the cluster heads 120a:120c might be selected will be disclosed next.

As disclosed above, in some examples each of the agent entities 300a:300c is provided in a respective user equipment 170a:170c. Then, in some embodiments, the agent entities 300a:300c are partitioned into the clusters 110a:110c based on estimated pathloss values between pairs of the user equipment 170a:170c. Let βₖₗ be the pathloss between agent entity k and agent entity l. Then βₗₖ=βₖₗ so there are in total K(K−1)/2 pathloss values to be estimated.

In some aspects, the pathloss values are estimated by having each agent entity transmit a pre-determined waveform that is known to all other agent entities. A traditional channel estimation procedure can then be performed from which the pathloss values can be estimated as a long-term average of the squared-magnitudes of the channel coefficients. The waveform can for example comprise a reference signal typically transmitted by a base station, such as primary synchronization signal (PSS) or a secondary synchronization signal (SSS) defined in the third generation partnership project (3GPP). The waveform can for example comprise a sidelink discovery channel as defined in 3GPP sidelink standards.

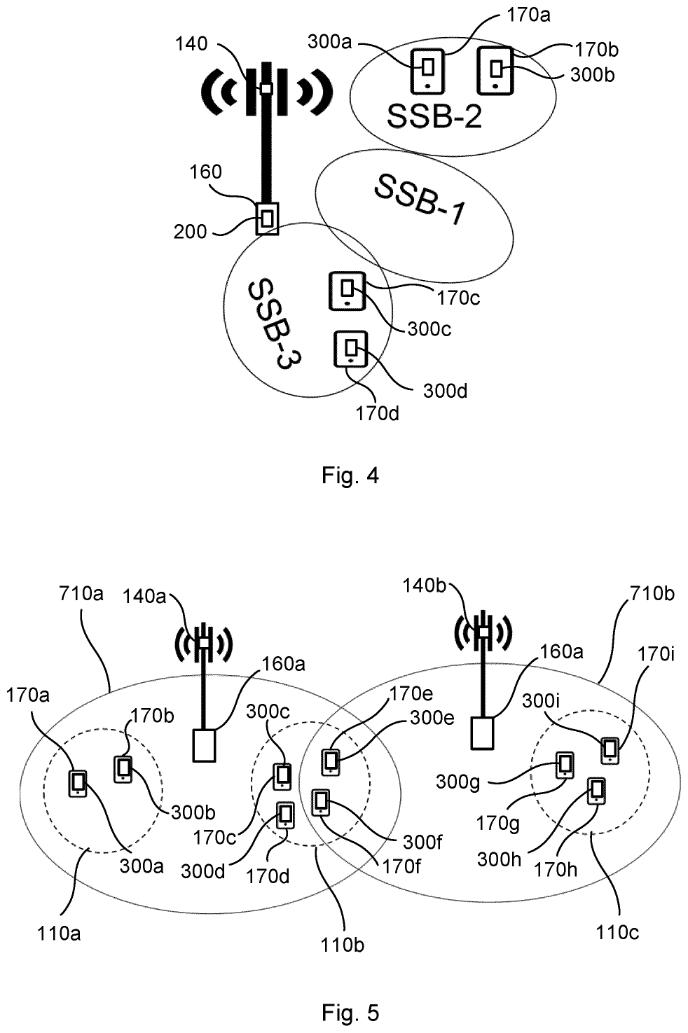

In some aspects, the pathloss values are estimated based on the radio location environment of the user equipment 170a:170c. Such pathloss values can, for example, be based on the Synchronization Signal block (SSB) index of the beam in which the user equipment 170a:170c is served. In particular, in some embodiments, the estimated pathloss values are estimated based on in which beams the user equipment 170a:170c are served by a network node 160, and the pathloss value of a first pair of user equipment 170a:170c served in the same beam is lower than the pathloss value of a second pair of user equipment 170a:170c served in different beams. Reference is here made to FIG. 4 which schematically illustrates a transmission and reception point 140 of a network node 160 transmitting an SSB in three beams, with one SSB index (denoted SSB-1, SSB-2, SSB-3 in FIG. 4) per beam. The network node 160 serves four user equipment 170a:170d, with one agent entity 300a:300d provided in each user equipment 170a:170d. In FIG. 4, the pathloss between user equipment 170a and user equipment 170b is assumed to be lower than the pathloss between user equipment 170a and user equipment 170c. This implies that the agent entity 300a and agent entity 300b are more likely to be part of the same cluster than agent entity 300a and agent entity 300c. Other types of radio environment information that can be used in similar are Channel State Information Reference Signal (CSI-RS) measurements or uplink channel information estimated from random access (RA) signalling or sounding reference signals (SRS).

In some aspects, the geographical locations of all of the agent entities are used to estimate the pathloss values. Particularly, in some embodiments, each of the user equipment 170a:170c is located at a respective geographical location, and the estimated pathloss value for a given pair of the user equipment 170a:170c depends on relative distance between the user equipment 170a:170c in this given pair of the user equipment 170a:170c as estimated using the geographical locations of the user equipment 170a:170c in this given pair of the user equipment 170a:170c. The pathloss values can be estimated by mapping pairs of geographical locations onto a pathloss value, for example, by querying a database of pre-determined pairwise pathlosses for pairs of geographical locations.

In some aspects, device sensor data can be used to estimate the relative geographical locations. That is, in some embodiments, the relative distance of the user equipment 170a:170c are estimated based on sensor data obtained by the user equipment 170a:170c. For example, similar sensor data values can indicate that the sensor data is collected from user equipment 170a:170c being relatively close to each other.

In some aspects, the pathloss value for the pair of agent entity k and agent entity I that are determined to be far away from one another geographically (for example, using positioning side information, or knowledge of their corresponding sectors/beams) is not obtained but simply set to βₖₗ=∞.

Aspects of how the agent entities 300a:300c might be partitioned into the clusters 110a:110c will be disclosed next.

In some embodiments, the estimated pathloss values represent connectivity information that is collected in a connectivity graph, and the agent entities 300a:300c are partitioned into the clusters 110a:110c based on the connectivity graph. For example, the clusters 110a:110c might be determined by running a clustering algorithm, for example spectral clustering, on the connectivity graph whose K×K (weighted) adjacency matrix A is obtained by setting Aₖₗ=1/βₖₗ.

In some examples, two agent entities k and l are considered connected if βₖₗ<T for some pre-determined threshold T. An unweighted connectivity graph with K×K adjacency matrix A might then be defined by setting Aₖₗ=1 if agent entities k and l are connected, and 0 otherwise. A community detection algorithm can then be applied, for example, spectral modularity maximization with bisection, or any other method known in the art, for the actual determination of the clusters 110a:110c.

Depending on the clustering algorithm employed, the number of clusters 110a:110c might be automatically obtained. For example, if bisection with modularity maximization is applied to detect communities in an unweighted connectivity graph, then the algorithm stops when modularity no longer can be increased through further subdivision of the graph. But it is also possible to stop any of the clustering algorithms by imposing a condition that there be a pre-determined number of clusters 110a:110c, or that the cluster sizes lie within pre-determined minimum and maximum levels. In this respect, in some examples, the number of clusters 110a:110c is determined as a function of the total available amount of radio resources (e.g., bandwidth, and time). The tradeoff is that if resources are scarce, then it is advantageous to use over-the-air transmission to the largest possible extent, that is, have only a few clusters 110a:110c. In contrasts, if resources are plentiful, then the system can afford to use unicast digital transmission from more, and smaller, clusters 110a:110c.

In some examples, the grouping is be based on other techniques to identify devices which are in the proximity of each other, e.g., location-based services positioning or Proximity-based services (ProSe) discovery procedures as proposed in Release 12 and Release 13 of the Long Term Evolution (LTE) telecommunication suite of standards.

In some examples, two or more of the above aspects, embodiments, and/or examples are combined to determine the clusters 110a:110c. For instance, the transmission and reception points may transmit several positioning reference signals in several beams (for example in several SSBs), request the user equipment to measure and report the received signal strengths, and then group the user equipment (and thus the agent entities provided in the user equipment) based on the received measurements. For example, the user equipment with similar reported signal strength on a certain beam and a reference signal can be grouped together in the same cluster.

Aspects of how the cluster heads 120a:120c might be selected will be disclosed next.

Let C be a set that contains the indices of the agent entities in a particular cluster.

In some aspects, the lowest maximum pathloss to other agent entities within the same cluster is used as metric for selecting cluster heads 120a:120c. In particular, in some embodiments, within each of the clusters 110a:110c, the agent entity of the user equipment 170a:170c having lowest maximum estimated pathloss to the other user equipment 170a:170c of the agent entities 300a:300c within the same cluster 110a:110c is selected as cluster head 120a:120c. That is, the cluster head for cluster C might be selected to be the agent entity k∈C for which

$${max}_{l ∈ C , l \neq k} {β}_{lk}$$

is the smallest.

In some aspects, the lowest pathloss to the server entity 200 is used as metric for selecting cluster heads 120a:120c. In particularly, in some embodiments, each of the user equipment 170a:170c is served by a network node, and, within each of the clusters 110a:110c, the agent entity of the user equipment 170a:170c having lowest estimated pathloss to the serving network node is selected as cluster head 120a:120c. Let αₖ be the pathloss from agent entity k to the server entity 200. The cluster head of cluster C is then selected to be the agent entity k∈C which has the smallest αₖ, i.e., the least pathloss to the server entity 200. In a variation on this example, the cluster head of cluster C is selected to be the agent entity k∈C for which

$$f ( {α}_{k} , {max}_{l ∈ C , l \neq k} {β}_{lk} )$$

is the smallest, where ƒ(.,.) is a pre-determined function. For example, ƒ(.,.) can be taken as ƒ(a, b)=max(a, b) or ƒ(a, b)=max(γa, b) for some pre-determined positive constant γ.

In some aspects, device information is used as metric for selecting cluster heads 120a:120c. In particularly, in some embodiments, each of the agent entities 300a:300c is provided in a respective user equipment 170a:170c, and the cluster heads 120a:120c are selected based on device information of the user equipment 170a:170c. This can be useful when not all user equipment 170a:170c, for example, due to security restrictions, are allowed to be cluster heads 120a; 120c. In some non-limiting examples, the device information pertains to any, or any combination of: device manufacturer, original equipment manufacturer (OEM) vendor, device model, chipset vendor, chipset model, user equipment category, user equipment class. Also other types of device information might be considered, such as battery status; an agent entity might only be selectable as cluster head if the user equipment in which the agent entity is provided is connected to a power source, or having battery level above a certain threshold value.

In some aspects, the cluster heads 120a:120c are selected before the clusters 110a:110c are selected. In particular, in some embodiments, the cluster heads 120a:120c are selected before the agent entities 300a:300c are partitioned into the clusters 110a:110c. The remaining agent entities not selected as cluster heads are then requested to measure on the reference signals transmitted by cluster heads 120a:120c. These measurements are then used to group the agent entities in different clusters 110a:110c. That is, which of the agent entities 300a:300c to be included in each cluster 110a:110c might then be based on measurements performed by the user equipment 170a:170c (of the agent entities 300a:300c) on reference signals transmitted by the user equipment 170a:170c of the cluster heads 120a:120c. For this purpose, the agent entities selected as cluster heads might be assigned orthogonal reference signals and instructed to transmit them on specific resources.

In some aspects, the cluster heads are, for example in step S106, configured with an update criterion for whether the unicast digital transmission for a given iteration of the iterative learning process is to be performed to the server entity or not. The update criterion could, for example, be based on the magnitude of model change, such as the model difference of the new cluster specific updated model, to the previous global model. Then, if the average absolute difference of the model update is not above a certain threshold, the cluster head can, according to the update criterion, skip reporting the model update for the current iteration of the iterative learning process and thereby reduce the signaling overhead. Alternatively, the cluster head might then indicate to the server entity that no aggregated local update needs to be sent to the server entity. In some aspects, if the number of cluster heads that indicate that no aggregated local update needs to be sent to the server entity exceeds a threshold value, the server entity might determine to terminate the iterative learning process. The update criterion could, for example, be based on the pathloss between the cluster head and the server entity. Then, if the pathloss as estimated by the cluster head is above a certain threshold, the cluster head can, according to the update criterion, skip reporting the model update for the current iteration of the iterative learning process and thereby reduce the signaling overhead. The update criterion could, for example, be based on outliers in the local updates received from the agent entities. Then, if the cluster head determines that some of the local updates comprises outliers, the cluster head can, according to the update criterion, discard such local updates when aggregate the local updates received from the agent entities and thereby reduce possible errors in the iterative learning process and thereby reduce the signaling overhead.

In some aspects, the partitioning of agent entities into clusters comprises determining a cluster priority, or cluster category, for each cluster, and assigning the determined cluster priority/category to each respective cluster. The cluster priority/category may be determined taking into consideration at least one of: type and/or number of agent entities of the cluster, estimated pathloss of the cluster head, or geographical location of the cluster head or agent entities of the cluster. For example, particular types of agent entities may be expected to contribute with more important parameter updates and/or a low estimated cluster head pathloss is preferred, resulting in a higher cluster priority. A cluster comprising particular types of agent entities, or agent entities located in a particular geographical area, may be determined to belong to a particular cluster category. In some aspects, the step of determining (and assigning) a cluster priority/category is performed subsequently of partitioning the agent entities into clusters.

In some aspects, the cluster priority/category determined and assigned to each cluster is be used to control which clusters that are to participate in a given iteration of the iterative learning process. For example, if the current network load exceeds a fixed or relative network load threshold, the cluster heads may be configured to not send updates if the cluster priority/category of the cluster so indicates. Alternatively, at a particular iteration of the iterative learning process, only parameter updates from clusters of a particular cluster category may be considered. The cluster priority/category may also be set to indicate that some clusters, if not in conflict with any other aspect disclosed herein, always are to be included when performing the iterative learning process.

Aspects of how the agent entities are to use over-the-air transmission with direct analog modulation for communicating local updates of the iterative learning process to the cluster head 120a:120c will be disclosed next.

In some aspects, transmissions within different clusters 110a:110c are scheduled on orthogonal resources. That is, in some embodiments, at least two of the clusters 110a:110c are assigned mutually orthogonal transmission resources for the over-the-air transmission. Such assignment of transmission resources might be made in order for the updates sent from agent entities within one cluster to not cause interference to the updates sent from agent entities within another cluster, which otherwise could be the case if these two clusters 110a:110c are geographically, or radio-wise, close to each other. For example, after determining the clusters 110a:110c and the cluster heads 120a:120c, a resource assignment for the over-the-air transmission in each cluster is made. This resource assignment is communicated to the clusters heads. The remaining agent entities in each cluster might then receive this information either from its cluster head or directly from the server entity 200.

In further aspects, two clusters 110a:110c deemed to be far away from one another can be assigned the same resources for the over-the-air transmission. That is, in some embodiments, a pair of clusters 110a:110c separated from each other more than a threshold value is configured with the same orthogonal transmission resources for the over-the-air transmission. For example, two clusters C and C′ deemed to be far away from one another in the pathloss sense (for example, if

$${min}_{k ∈ C , {k}^{′} ∈ {C}^{′}} {β}_{kl} > Γ$$

for some pre-determined threshold Γ), can be allocated the same resources for the over-the-air transmission. The threshold Γ can be selected based on a criterion that quantifies how much interference that is tolerated in the over-the-air transmission, and may be a function of the signal-to-noise-ratio as well (which is proportional to the smallest reciprocal pathloss in any of the clusters C and C′).

In some aspects, power control and phase rotation at the agent entities in the clusters 110a:110c is performed such that all agent entities' signals are received aligned in phase, and with the same power, at the cluster head 120a:120c. In particular, in some embodiments, the agent entities 300b, 300c are configured by the server entity 200 to perform power control and phase rotation with an objective to align power and phase at the cluster head 120a:120c for the local updates received by the cluster head 120a:120c from the agent entities 300b, 300c within the cluster 110a:110c.

Aspects of how the agent entities acting as cluster heads 120a:120c are to use unicast digital transmission for communicating aggregated local updates to the server entity 200 will be disclosed next.

The server entity 200 might, after the cluster heads 120a:120c have been selected, assign resources to the cluster heads for their transmission of the within-cluster aggregated data to the serve entity 200.

Further aspects of how the server entity 200 might perform the iterative learning process with the agent entities 300a:300c will be disclosed next.

In some aspects, the agent entities are partitioned into clusters over multiple cells, or serving network nodes. In particular, in some embodiments, at least two of the user equipment 170a:170c of agent entities 300a:300c within the same cluster 110a:110c are served by different network nodes. In this respect, the user equipment in which the agent entities are provided might have different serving cells but still be in vicinity of each other, for example being located on the cell border of two serving network nodes. In another scenario two or more network nodes are serving the same geographical region but are operating on different carrier frequencies. This can further reduce the number of clusters needed and thereby increase the efficiency of the system. Reference is here made to FIG. 4 which schematically illustrates two transmission and reception points 140a, 140b, each having its own network node 160a, 160b and serving a respective cell 710a, 710b. User equipment 170a:170d in which agent entities 300a:300d are provided are served by transmission and reception point 140a whereas user equipment 170e:170i in which agent entities 300e:300i are provided are served by two transmission and reception point 140b. The agent entities 300a:300i are partitioned into three clusters 110a:110c. Cluster 110b comprises both agent entities 300c, 300d provided in user equipment 170c, 170d served by transmission point 140a and agent entities 300e, 300f provided in user equipment 170e, 170f served by transmission point 140b. Hence, three clusters can be formed instead of four.

In this case, the different network nodes need to exchange information in order to build the connectivity graph (or for another type of metric based on the partitioning of the agent entities is determined). The different network nodes then need to be operatively connected to the server entity 200. In such case, the different network nodes might be regarded as relaying information from the server entity 200 to the agent entities and vice versa.

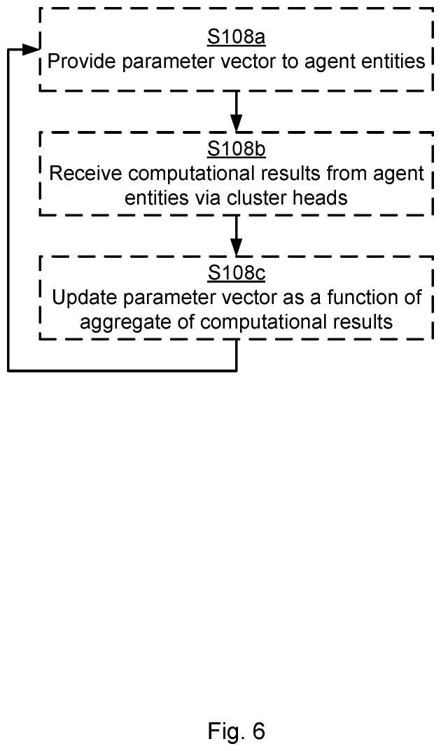

Aspects of how the at least one iteration of the iterative learning process can be performed will be disclosed next. Particular reference is here made to the flowchart of FIG. 6 showing optional steps of one iteration of the iterative learning process that might be performed by the server entity 200 during each iteration of the iterative learning process in S108.

S108a: The server entity 200 provides a parameter vector of the computational task to the agent entities 300a:300c.

S108b: The server entity 200 receives the computational results as a function of the parameter vector from the agent entities 300a:300c via the cluster heads 120a:120c using unicast digital transmission.

S110c: The server entity 200 updates the parameter vector as a function of an aggregate of the received computational results.

Step S108 (including S108a:S108c) can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

It is envisioned that the parameter vectors received from certain cluster heads can be ignored if certain conditions are, or are not, fulfilled. For example, if the estimated pathloss value of given cluster head exceeds some threshold value, the given cluster head may determine that the aggregated local updates are not that significant and could be ignored. For example, the cluster head may detect outlier in its local update etc.

It is envisioned that a cluster 110:110c (or even several clusters 110:110c) contains only a single agent entity. In this case, the agent entity in such a cluster is simply an agent entity that is excluded from using over-the-air transmission with direct analog modulation. Such agents are instead scheduled on orthogonal resources, and their gradient updates are transmitted to the server entity directly using unicast digital transmission. Typically, such agent entities are located far away from other agent entities, and likely far away from the server entity as well.

It is further envisioned that there might be scenarios with only two participating agent entities. In one setup, both these agent entities might be assigned as cluster heads, resulting in an overall unicast digital transmission scheme. In another setup, the two agent entities are assigned to a single cluster with one of the agent entities acting as the cluster head.

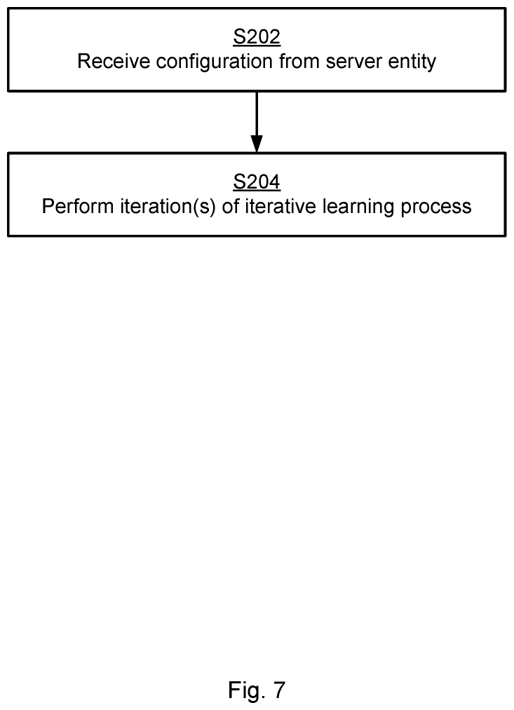

Reference is now made to FIG. 7 illustrating a method for performing an iterative learning process with a server entity 200 and a cluster head 120a:120c as performed by the agent entity 300b, 300c according to an embodiment. The agent entity 300b, 300c is part of a cluster 110a:110c having a cluster head 120a:120c.

S202: The agent entity 300b, 300c receives configuration from the server entity 200. According to the configuration, the agent entity 300b, 300c is to, as part of performing the iterative learning process, use over-the-air transmission with direct analog modulation for communicating local updates of the iterative learning process to the cluster head 120a:120c.

S204: The agent entity 300b, 300c performs at least one iteration of the iterative learning process with the server entity 200 and the cluster head 120a:120c according to the configuration.

Embodiments relating to further details of performing an iterative learning process with a server entity 200 and a cluster head 120a:120c as performed by the agent entity 300b, 300c will now be disclosed.

The different embodiments disclosed above with reference to the server entity 200 that involve the agent entity 300b, 300c also apply here and are omitted for brevity and to avoid unnecessary repetition and possible confusion of this disclosure.

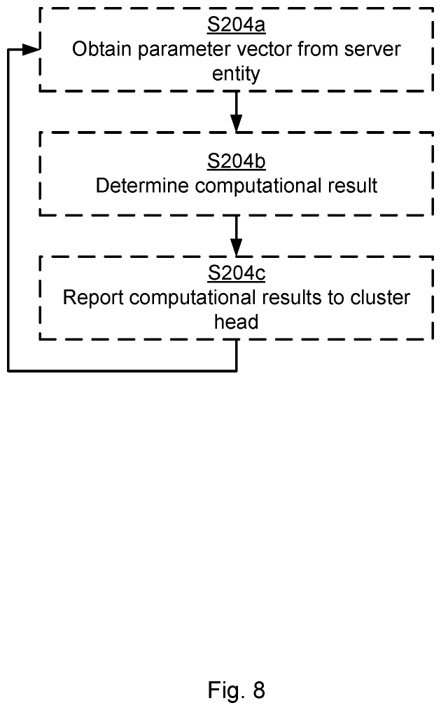

Reference is next made to the flowchart of FIG. 8 showing optional steps of one iteration of the iterative learning process that might be performed by the agent entity 300b, 300c during each iteration of the iterative learning process in S204.

S204a: The agent entity 300b, 300c obtains a parameter vector of the computational problem from the server entity 200.

S204b: The agent entity 300b, 300c determines the computational result of the computational task as a function of the obtained parameter vector for the iteration and of data locally obtained by the agent entity 300b, 300c.

S204c: The agent entity 300b, 300c reports the computational result to its cluster head 120a:120c using over-the-air transmission with direct analog modulation.

Step S204 (including S204a: S204c) can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

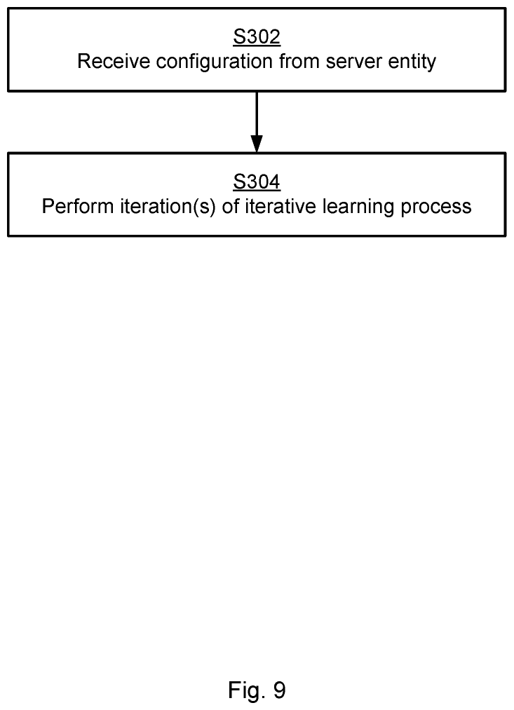

Reference is now made to FIG. 9 illustrating a method for performing an iterative learning process with a server entity 200 and other agent entities 300b, 300c as performed by the agent entity 300a according to an embodiment. The agent entity 300a acts as a cluster head 120a:120c of a cluster 110a:110c of the other agent entities 300a:300c

S302: The agent entity 300a receives configuration from the server entity 200. According to the configuration, the agent entity is to, as part of performing the iterative learning process, aggregate local updates received in over-the-air transmission with direct analog modulation from the agent entities 300b, 300c within the cluster 110a:110c and to use unicast digital transmission for communicating the aggregated local updates to the server entity 200.

S304: The agent entity 300a performs at least one iteration of the iterative learning process with the server entity 200 and the agent entities 300b, 300c within the cluster 110a:110c according to the configuration.

Embodiments relating to further details of performing an iterative learning process with a server entity 200 and agent entities 300b, 300c as performed by the agent entity 300a will now be disclosed.

The different embodiments disclosed above with reference to the server entity 200 that involve the agent entity 300a acting as cluster head also apply here and are omitted for brevity and to avoid unnecessary repetition and possible confusion of this disclosure.

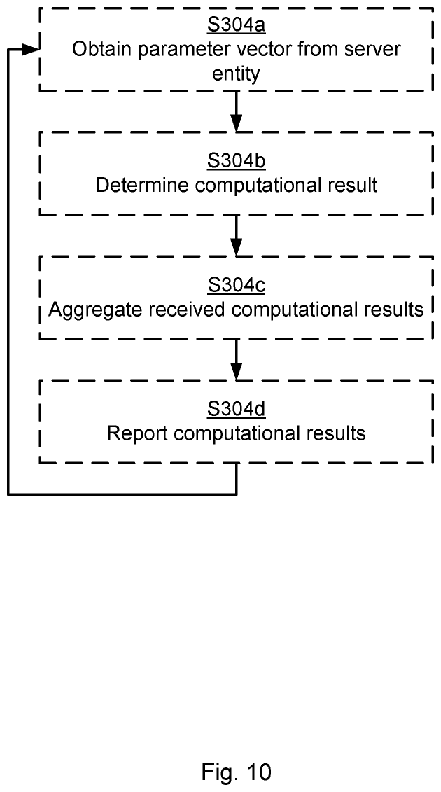

Reference is next made to the flowchart of FIG. 10 showing optional steps of one iteration of the iterative learning process that might be performed by the agent entity 300a acting as cluster head during each iteration of the iterative learning process in S304.

S304a: The agent entity 300a obtains a parameter vector of the computational problem from the server entity 200.

S304b: The agent entity 300a determines the computational result of the computational task as a function of the obtained parameter vector for the iteration and of data locally obtained by the agent entity 300a.

S304c: The agent entity 300a receives and aggregates computational results from the other agent entities 300b, 300c in the cluster using over-the-air transmission with direct analog modulation.

S304d: The agent entity 300a reports the computational result to the server entity 200 using unicast digital transmission.

Step S304 (including S304a: S304c) can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

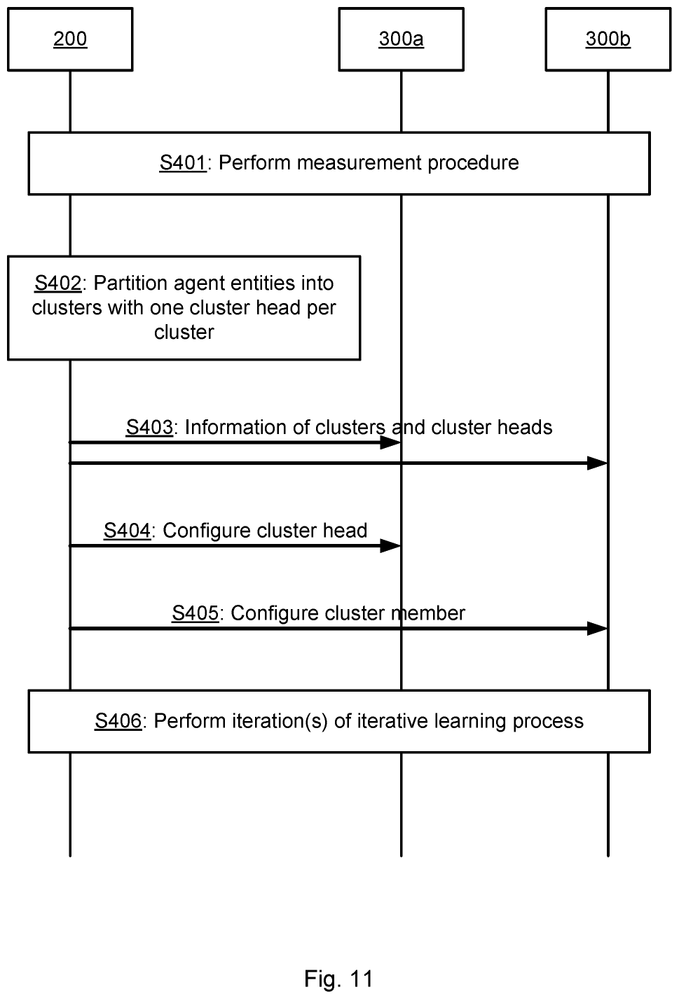

One particular embodiment for performing an iterative learning process based on at least some of the above disclosed embodiments will now be disclosed in detail with reference to the signalling diagram of FIG. 11.

S401: A measurement procedure is performed between the agent entities 300a, 300b and the server entity 200. This measurement procedure might pertain to any of the above disclosed factors based on which the agent entities 300a, 300b might be partitioned into the clusters and/or based on which the cluster heads might be selected.

S402: The server entity 200 partitions, based at least on measurement procedure, the agent entities 300a, 300b into clusters.

S403: The server entity 200 provides information to the agent entities 300a, 300b about the clusters and the cluster heads. Each agent entity 300a, 300b then knows if it will act as a cluster head or a cluster member. Each agent entity 300 that will act as cluster head is informed of which other agent entities are members of its cluster. Each agent entity 300b that will act as a cluster member is informed of its cluster head.

S404: The server entity 200 configures the agent entities that will act as a cluster head to, as part of performing the iterative learning process, aggregate the local updates received from the agent entities within its cluster, and to use unicast digital transmission for communicating aggregated local updates to the server entity 200.

S405: The server entity 200 configures the agent entities that will act as cluster members to, as part of performing the iterative learning process, use over-the-air transmission with direct analog modulation for communicating local updates of the iterative learning process to the cluster head.

S406: At least one iteration of the iterative learning process is performed. During each iteration the following steps are performed. The server entity 200 provides a parameter vector of the computational task to the agent entities 300a, 300b. Each of the agent entities 300a, 300b determines a respective computational result of the computational task as a function of the obtained parameter vector for the iteration and of data locally obtained by the agent entity 300a, 300b. The agent entity 300b acting as a cluster member reports the computational result to the agent entity 300a acting as its cluster head using over-the-air transmission with direct analog modulation. The agent entity 300a acting as cluster head aggregates the computational results from the other agent entities 300b in the cluster using over-the-air transmission with direct analog modulation. The agent entity 300a acting as cluster head reports the computational result to the server entity 200 using unicast digital transmission. The server entity 200 updates the parameter vector as a function of an aggregate of the received computational results.

It has above been specified that the cluster heads 120a:120c are configured to, as part of performing the iterative learning process, to use unicast digital transmission for communicating the aggregated local updates to the server entity 200. However, it is envisioned that there might be scenarios where the communication between at least some of the cluster heads 120a:120c and the server entity 200 follows over-the-air computation principles. It is thus envisioned that, alternatively, the cluster heads 120a:120c are configured to, as part of performing the iterative learning process, to use over-the-air transmission with direct analog modulation for communicating the aggregated local updates to the server entity 200. This alternative could thus be incorporated in step S104 as well as in step S302. Hence, the communication between agent entities acting as cluster heads and the server entity follows over-the-air computation principles.

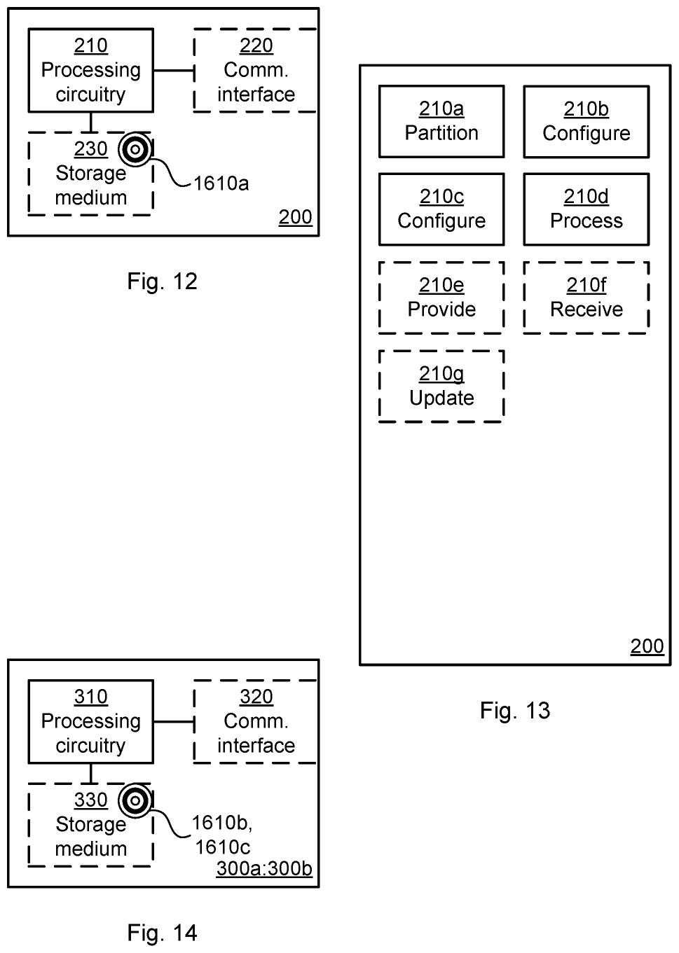

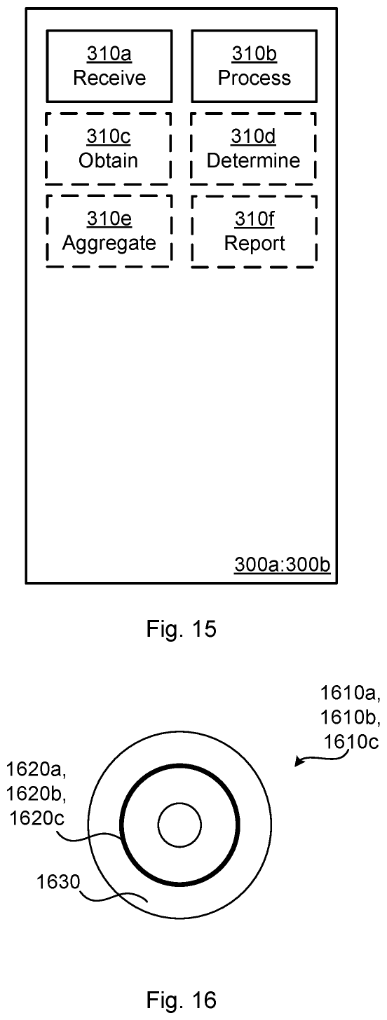

FIG. 12 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1610a (as in FIG. 16), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 13 schematically illustrates, in terms of a number of functional modules, the components of a server entity 200 according to an embodiment. The server entity 200 of FIG. 13 comprises a number of functional modules; a partition module 210a configured to perform step S102, a (first) configure module 210b configured to perform step S104, a (second) configure module (210c) configured to perform step S106, and a process module (210d) configured to perform step S108. The server entity 200 of FIG. 13 may further comprise a number of optional functional modules, such as any of a provide module 210e configured to perform step S108a, a receive module 210f configured to perform step S108b, and an update module 210g configured to perform step S108c. In general terms, each functional module 210a:210g may be implemented in hardware or in software. Preferably, one or more or all functional modules 210a:210g may be implemented by the processing circuitry 210, possibly in cooperation with the communications interface 220 and the storage medium 230. The processing circuitry 210 may thus be arranged to from the storage medium 230 fetch instructions as provided by a functional module 210a:210g and to execute these instructions, thereby performing any steps of the server entity 200 as disclosed herein.

The server entity 200 may be provided as a standalone device or as a part of at least one further device. For example, the server entity 200 may be provided in a node of a radio access network or in a node of a core network. Examples of where the server entity 200 may be provided have been disclosed above. Alternatively, functionality of the server entity 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 12 the processing circuitry 210 may be distributed among a plurality of devices, or nodes. The same applies to the functional modules 210a:210g of FIG. 13 and the computer program 1610a of FIG. 16.

FIG. 14 schematically illustrates, in terms of a number of functional units, the components of an agent entity 300a:300c according to an embodiment. Each agent entity 300a:300c might selectively act as either a cluster member or a cluster head. Processing circuitry 310 is provided using any combination of one or more of a suitable central processing unit (CPU), multiprocessor, microcontroller, digital signal processor (DSP), etc., capable of executing software instructions stored in a computer program product 1610b (as in FIG. 16), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300a:300c to perform a set of operations, or steps, as disclosed above. For example, the storage medium 330 may store the set of operations, and the processing circuitry 310 may be configured to retrieve the set of operations from the storage medium 330 to cause the agent entity 300a:300c to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300a:300c may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300a:300c e.g. by sending data and control signals to the communications interface 320 and the storage medium 330, by receiving data and reports from the communications interface 320, and by retrieving data and instructions from the storage medium 330. Other components, as well as the related functionality, of the agent entity 300a:300c are omitted in order not to obscure the concepts presented herein.

FIG. 15 schematically illustrates, in terms of a number of functional modules, the components of an agent entity 300a:300c according to an embodiment. The agent entity 300a:300c of FIG. 15 comprises a number of functional modules; a receive module 310a configured to perform step S202 and/or S302, and a process module 310b configured to perform step S204 and/or S304. The agent entity 300a:300c of FIG. 15 may further comprise a number of optional functional modules, such as any of an obtain module configured to perform step S204a and/or S304a, a determine module configured to perform step S204b and/or S304b, an aggregate module configured to perform step S304c, and a report module configured to perform step S204c and/or S304d. In general terms, each functional module 310a:310f may be implemented in hardware or in software. Preferably, one or more or all functional modules 310a:310f may be implemented by the processing circuitry 310, possibly in cooperation with the communications interface 320 and the storage medium 330. The processing circuitry 310 may thus be arranged to from the storage medium 330 fetch instructions as provided by a functional module 310a:310f and to execute these instructions, thereby performing any steps of the agent entity 300a:300c as disclosed herein.

FIG. 16 shows one example of a computer program product 1610a, 1610b, 1610c comprising computer readable means 1630. On this computer readable means 1630, a computer program 1620a can be stored, which computer program 1620a can cause the processing circuitry 210 and thereto operatively coupled entities and devices, such as the communications interface 220 and the storage medium 230, to execute methods according to embodiments described herein. The computer program 1620a and/or computer program product 1610a may thus provide means for performing any steps of the server entity 200 as herein disclosed. On this computer readable means 1630, a computer program 1620b can be stored, which computer program 1620b can cause the processing circuitry 310 and thereto operatively coupled entities and devices, such as the communications interface 320 and the storage medium 330, to execute methods according to embodiments described herein. The computer program 1620b and/or computer program product 1610b may thus provide means for performing any steps of the agent entity 300b, 300c as herein disclosed. On this computer readable means 1630, a computer program 1620c can be stored, which computer program 1620c can cause the processing circuitry 310 and thereto operatively coupled entities and devices, such as the communications interface 320 and the storage medium 330, to execute methods according to embodiments described herein. The computer program 1620c and/or computer program product 1610c may thus provide means for performing any steps of the agent entity 300a as herein disclosed.

In the example of FIG. 16, the computer program product 1610a, 1610b, 1610c is illustrated as an optical disc, such as a CD (compact disc) or a DVD (digital versatile disc) or a Blu-Ray disc. The computer program product 1610a, 1610b, 1610c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620a, 1620b, 1620c is here schematically shown as a track on the depicted optical disk, the computer program 1620a, 1620b, 1620c can be stored in any way which is suitable for the computer program product 1610a, 1610b, 1610c.

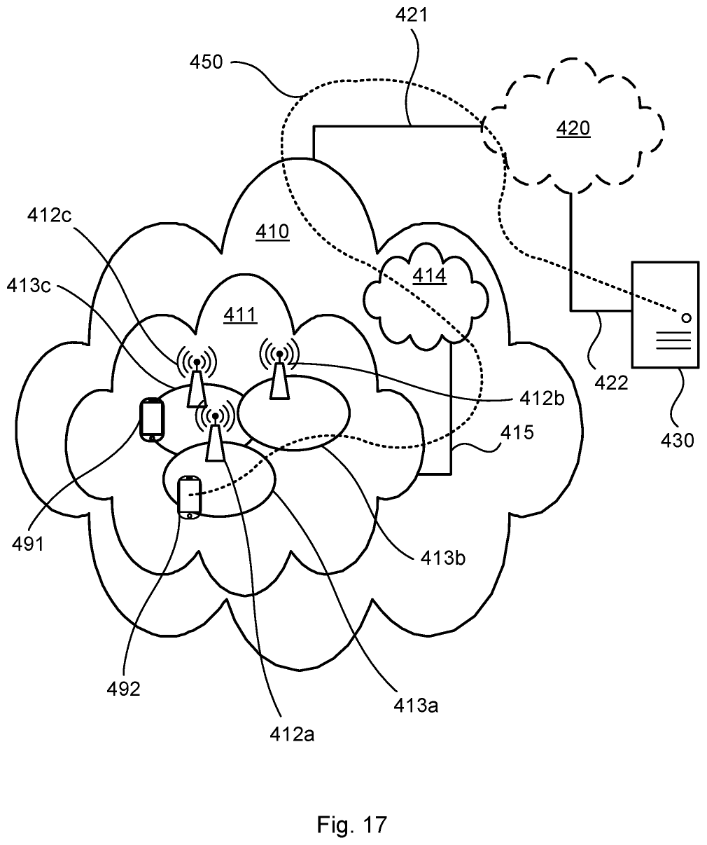

FIG. 17 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, and core network 414. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 170a:170c of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 17 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

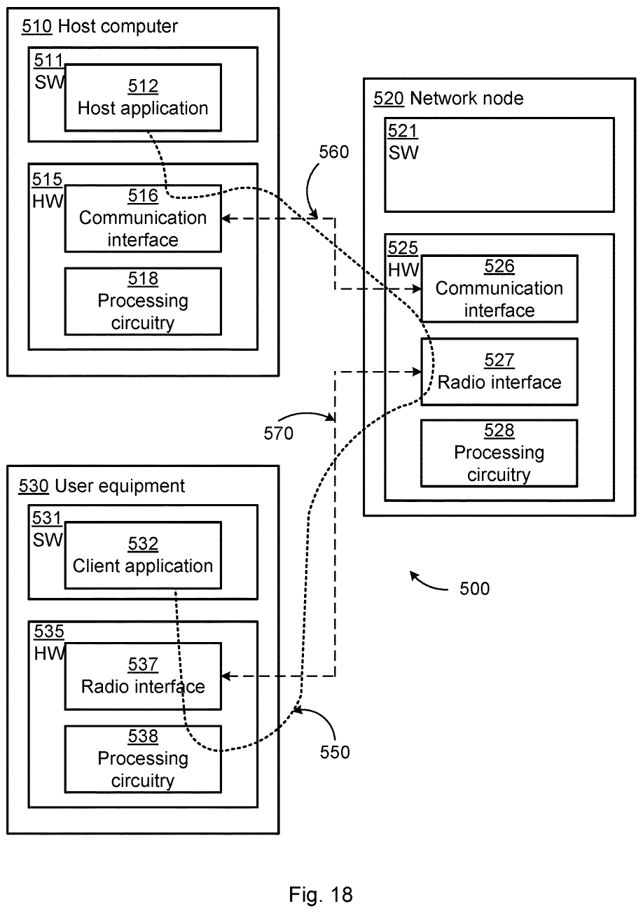

FIG. 18 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 18. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 170a:170c of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 18) served by radio access network node 520. Communication interface 526 may be configured to facilitate connection 560 to host computer 510. Connection 560 may be direct or it may pass through a core network (not shown in FIG. 18) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 18 may be similar or identical to host computer 430, one of network nodes 412a, 412b, 412c and one of UEs 491, 492 of FIG. 17, respectively. This is to say, the inner workings of these entities may be as shown in FIG. 18 and independently, the surrounding network topology may be that of FIG. 17.

In FIG. 18, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-25. (canceled)

26. A method for performing an iterative learning process with agent entities, the method being performed by a server entity, the method comprising:
partitioning the agent entities into clusters with one cluster head per each of the clusters;
configuring the agent entities to, as part of performing the iterative learning process, use over-the-air transmission with direct analog modulation for communicating local updates of the iterative learning process to the cluster head;
configuring the cluster head of each cluster to, as part of performing the iterative learning process: aggregate the local updates received from the agent entities within its cluster, and use unicast digital transmission for communicating aggregated local updates to the server entity; and
performing at last one iteration of the iterative learning process with the agent entities and the cluster heads according to the configuration.

27. The method of claim 26, wherein at least two of the clusters are assigned mutually orthogonal transmission resources for the over-the-air transmission.

28. The method of claim 26, wherein a pair of clusters separated from each other more than a threshold value is configured with the same orthogonal transmission resources for the over-the-air transmission.

29. The method of claim 26, wherein the agent entities are configured by the server entity to perform power control and phase rotation with an objective to align power and phase at the cluster head for the local updates received by the cluster head from the agent entities within the cluster.

30. The method of claim 26, wherein each of the agent entities is provided in a respective user equipment, and wherein the agent entities are partitioned into the clusters based on estimated pathloss values between pairs of the user equipment.

31. The method of claim 30, wherein the estimated pathloss values are estimated based on in which beams the user equipment are served by a network node, and wherein the pathloss value of a first pair of user equipment served in the same beam is lower than the pathloss value of a second pair of user equipment served in different beams.

32. The method of claim 30, wherein each of the user equipment is located at a respective geographical location, and wherein the estimated pathloss value for a given pair of the user equipment depends on relative distance between the user equipment in said given pair of the user equipment as estimated using the geographical locations of the user equipment in said given pair of the user equipment.

33. The method of claim 32, wherein the relative distance of the user equipment are estimated based on sensor data obtained by the user equipment.

34. The method of claim 30, wherein the estimated pathloss values represent connectivity information that is collected in a connectivity graph, and wherein the agent entities are partitioned into the clusters based on the connectivity graph.

35. The method of claim 30, wherein, within each of the clusters, the agent entity of the user equipment having lowest maximum estimated pathloss to the other user equipment of the agent entities within the same cluster is selected as cluster head.

36. The method of claim 30, wherein each of the user equipment is served by a network node, and wherein, within each of the clusters, the agent entity of the user equipment having lowest estimated pathloss to the serving network node is selected as cluster head.

37. The method of claim 26, wherein each of the agent entities is provided in a respective user equipment, and wherein the cluster heads are selected based on device information of the user equipment.

38. The method of claim 26, wherein each of the agent entities is provided in a respective user equipment, wherein the cluster heads are selected before the agent entities are partitioned into the clusters, and wherein which of the agent entities to be included in each cluster is based on measurements performed by the user equipment of the agent entities on reference signals transmitted by the user equipment of the cluster heads.

39. The method of claim 26, wherein each of the agent entities is provided in a respective user equipment, and wherein at least two of the user equipment of agent entities within the same cluster are served by different network nodes.

40. The method of claim 26, wherein the server entity is provided in any of: an access network node, a core network node, an Operations, Administration and Maintenance node, a Service Management and Orchestration node.

41. The method of claim 26, wherein in at least one of the clusters, one of the agent entities acts as cluster head.

42. A method for performing an iterative learning process with a server entity and a cluster head, the method being performed by an agent entity, wherein the agent entity is part of a cluster having a cluster head, the method comprising:
receiving configuration from the server entity, wherein according to the configuration, the agent entity is to, as part of performing the iterative learning process, use over-the-air transmission with direct analog modulation for communicating local updates of the iterative learning process to the cluster head; and
performing at least one iteration of the iterative learning process with the server entity and the cluster head according to the configuration.

43. A method for performing an iterative learning process with a server entity and agent entities, the method being performed by an agent entity, wherein the agent entity acts as a cluster head of a cluster of agent entities, the method comprising:
receiving configuration from the server entity, wherein according to the configuration, the agent entity is to, as part of performing the iterative learning process, aggregate local updates received in over-the-air transmission with direct analog modulation from the agent entities within the cluster and to use unicast digital transmission for communicating the aggregated local updates to the server entity; and
performing at least one iteration of the iterative learning process with the server entity and the agent entities within the cluster according to the configuration.

44. A server entity for performing an iterative learning process with agent entities, the server entity comprising processing circuitry, the processing circuitry being configured to cause the server entity to:
partition the agent entities into clusters with one cluster head per each of the clusters;
configure the agent entities to, as part of performing the iterative learning process, use over-the-air transmission with direct analog modulation for communicating local updates of the iterative learning process to the cluster head;
configure the cluster head of each cluster to, as part of performing the iterative learning process: aggregate the local updates received from the agent entities within its cluster, and use unicast digital transmission for communicating aggregated local updates to the server entity; and
perform at last one iteration of the iterative learning process with the agent entities and the cluster heads according to the configuration.
